(19) United States
(12) Patent Application Publication
(10) Pub. No.: US 2008/0010016 A1
(43) Pub. Date: Jan. 10, 2008

(54) Distribution Center Processing of Vehicles and Cargo

(76) Inventors: Edward S. Wickey, Satellite Beach, FL (US); David Simono, Austin, TX (US); Maria J. Wickey, Satellite Beach, FL (US); Craig Moeller, West Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/774,199

(22) Filed: Jul. 6, 2007

Related U.S. Application Data
(60) Provisional application No. 60/806,653, filed on Jul. 6, 2006.

(51) Int. Cl. G01C 21/00; B60Q 1/00

(52) U.S. Cl. 701/213; 340/438

(57) ABSTRACT

The efficiency with which loads carried by vehicles can be off-loaded is improved by allowing vehicle personnel or companies shipping goods by vehicle to directly schedule personnel and other resources needed for off-loading automatically without human intervention. During off-loading, information related to the off-loading is captured by dock personnel using a hand held terminal and sent to a database. The hand held terminal permits capture of images related to the load, including images of goods damaged during shipment. Control of access to an automated system is controlled by log-in identification and password. The privileges and format of information provided to a user is dictated by the log-in identification.

### CROSS REFERENCE TO RELATED APPLICATIONS

This application claims priority to and incorporates by reference in its entirety U.S. Provisional Application Ser. No. 60/806,653, filed Jul. 6, 2006, entitled Distribution Center Processing of Vehicles and Cargo by inventors Edward Wickey, David Simono, Maria Wickey and Craig Moeller, which is incorporated herein by reference in its entirety.

This application is directed to techniques for processing of vehicles and cargo at a distribution center and to methods, apparatus, systems, computer program products, and methods of doing business related thereto.

### BACKGROUND OF THE INVENTION

1. Field of the Invention

The invention is directed to unloading of vehicles at a distribution point and more particularly to techniques, methods, systems, apparatus and computer program products for improving the scheduling, unloading and accounting for products delivered by vehicle to a distribution point.

2. Description of the Prior Art

Techniques for shipping of freight and for tracking vehicles and managing fleets of vehicles are known in the art. For example, U.S. Pat. No. 6,474,927 to McAdams et al. discloses techniques for transportation and accounting for containers being delivered to a distribution point.

U.S. Pat. No. 6,611,755 to Coffee et al. describes a vehicle fleet management system which identifies the location and direction of movement of each vehicle in a fleet of vehicles in real time and automatically reports the information as well as the status of predetermined events in which the vehicle is engaged to a fleet manager.

However, neither of these inventions is directed to the problems that exist in managing the unloading of vehicles at a distribution center as described hereinafter.

A distribution center or distribution point is operated, typically, by an owner of the distribution center. A typical owner of a distribution center might be a grocery chain which receives large shipments by truck or other vehicle at the distribution center. The trucks or other vehicles are unloaded and the products placed in inventory until such time as they are needed to be sent to the individual stores of the grocery chain.

The drivers of trucks that arrive at the distribution center are not engaged to load and unload the trucks. As a result, either the distribution center maintains a staff of stevedores to load and unload the trucks or they contract with an organization that does provide the necessary staffing. Contracting out the loading and unloading function of the distribution center is desirable because the owner of the site then does not need to provide liability insurance or workmen's compensation for the staff. The distribution center also does not need to absorb the downtime when no trucks arrive by having permanent employees sitting idle until a truck comes into the distribution center for unloading.

As a result, practices evolved in the industry in which the owners of the distribution centers contract with a source of temporary labor to handle the loading and unloading of vehicles. There are often contractual penalties involved for either the supplier or the truck bringing the supplies if the truck arrives late.

There are a number of problems associated with the prior art approach to unloading vehicles at a distribution center. First, if the labor resources aren't available, unnecessary delays in unloading the truck may occur with the possibilities of penalties being assessed at some point in the delivery chain. About 60% of the vehicles scheduled for unloading are scheduled through the owner of the site. The rest occurs through brokers or individual truckers showing up.

A set of problems are associated with having the driver be the sole source of information going back to the company that engages the driver to deliver the goods to the distribution point. In the past, the driver has been the main source of information relating to 1) the driver's time at the site; 2) the type of load (whether the load was palletized or consisted of individual cases); 3) reconciling the count of the cases and pallets delivered to the distribution point and the cost of unloading the load at the distribution point.

It is customary in the business for the driver to be paid cash on the dock for the delivery. Another problem in managing the unloading a vehicle at the distribution point involves the fact that independent truckers often show up unannounced resulting in delays to other trucks that were expected in the unloading process.

### BRIEF SUMMARY OF THE INVENTION

The invention is directed to improve techniques for overcoming the problems of the prior art, and, more particularly, to methods, apparatus, systems, computer program products and methods of doing business related thereto.

Specifically, the invention is directed to computer based systems, apparatus, methods and methods of doing business which facilitate the automatic scheduling and reporting of the unloading of vehicles at distribution centers.

### BRIEF DESCRIPTION OF THE DRAWINGS

FIG. 1 is a block diagram showing functional navigation of a computer server in accordance with one aspect of the invention.

FIG. 2 is a diagram showing an exemplary main menu shown in FIG. 1.

FIG. 3 is a diagram showing a screen for entry of information used to schedule a truck for servicing at a distribution center.

FIG. 4 is a diagram of an exemplary screen permitting export of information related to truck scheduling to an Excels spreadsheet.

FIG. 5 is a diagram of an exemplary screen showing a view of purchase order information entered preferably at the time of scheduling a truck for service at a distribution center.

FIG. 6 is a diagram illustrating functionality accessible through the administration selection of the main menu shown in FIG. 2.

FIG. 7 is a diagram illustrating functionality accessible through the Operations selection of this main menu shown in FIG. 2.

FIG. 8 is a diagram illustrating functionality accessible through the Reports selection of the main menu shown in FIG. 2.

FIG. 9 is an illustration of an exemplary DOT report shown in FIG. 8.

FIG. 10 is an illustration of an OPS report selection window activated by selection of the OPS report functionality shown in FIG. 8.

FIG. 11 shows an exemplary OPS report generated from information entered in the OPS report selection window of FIG. 10.

FIG. 12 is a block diagram of the steps users of the system disclosed herein take to process unloading of a vehicle at a distribution center.

FIG. 13 is a picture showing use of a hand held terminal to capture an image of damage identified upon unloading to goods received.

FIG. 14 is an exemplary view of purchase order information after job completion.

FIG. 15 is an exemplary layout of a Key Performance Indicator (KPI) report.

FIG. 16 is a diagram of a purchase order search screen.

FIG. 17 is a diagram showing a hand held terminal or a wireless equiped truck and its interaction with the database associated with a local host or a remote server.

### DETAILED DESCRIPTION OF THE INVENTION

As noted above, the problems of unloading vehicles at a distribution center include insuring an adequate staff of personnel to load and unload the trucks while, at the same time, avoiding the down time that results from having permanent employees sitting around idle until a truck comes to the distribution center for unloading. In accordance with the invention, an integrated set of services are provided to shippers and to truckers and to operators of distribution centers that permit the problems of the prior art to be significantly overcome.

One aspect of solving the problems of the prior art involves the use of a server, interacting with a database, in novel ways, which permits the problems of the prior art to be overcome.

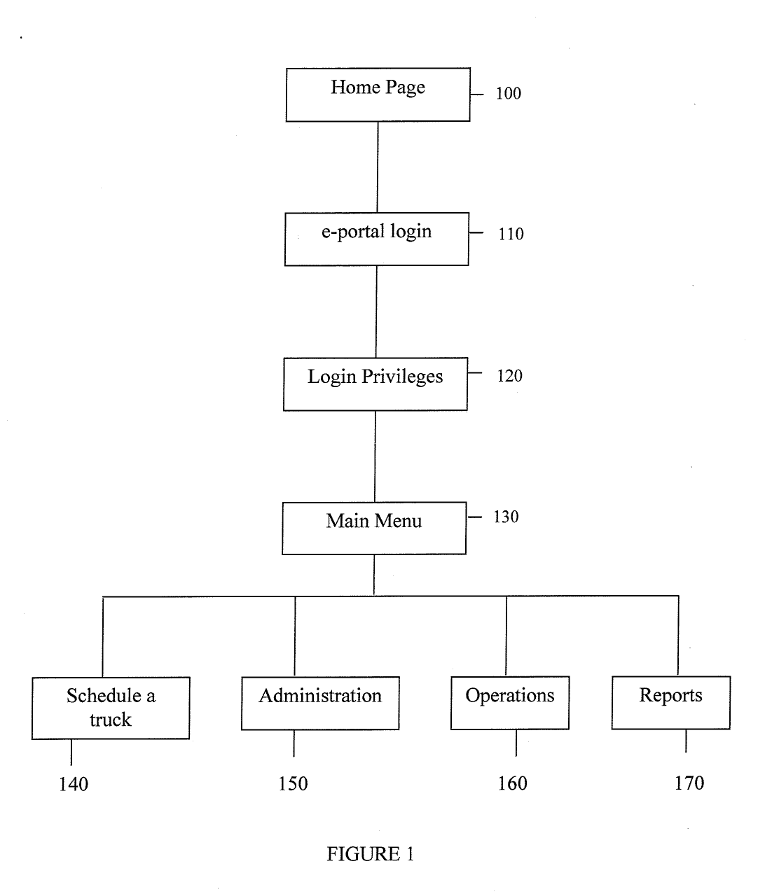

FIG. 1 is a block diagram showing functional navigation of a computer server in accordance with one aspect of the invention. In a preferred embodiment, a user logs on to the home page of a company managing the servicing of vehicles at a distribution point. A home page, 100, is preferably, an HTML based page accessible via wire or wireless connections. When a user accesses the home page, he will undertake an e-portal login 110. This provides him with access to the functionality of the server. With entry of the users identification information, typically, a log in identification and password, the server checks for the privileges associated with the user. The privileges available to a user are dependant upon the user's role. In one case, the log in identification and password may indicate that the user is a trucker. Only the functions that should be available to a trucker are then accessible to the trucker through that log in (item 120). If the user is a client company, a different and broader set of privileges are available to a client company user, including the acquisition of reports that are specific to the client company. If the user logging in to the server is an employee of the company managing the staffing on the docks of the distribution center, there may be various levels of privilege depending upon whether the employee logging on is a dock worker, a manager, or an executive or other officer of the company. Once the user is successfully logged in, the user is provided access to a main menu 130. The functionalities that are not permitted to the user logging in with be either grayed out or just not visible to such a user logging in.

The main menu provides access to functionalities such a scheduling a truck (140), administration (150), operations (160) and reports (170). Note that the set of reports available to the user logging in maybe specific to a particular customer. In fact, the reports maybe customized for a particular customers needs and be available only to users from that company upon successful log in by a user from that company.

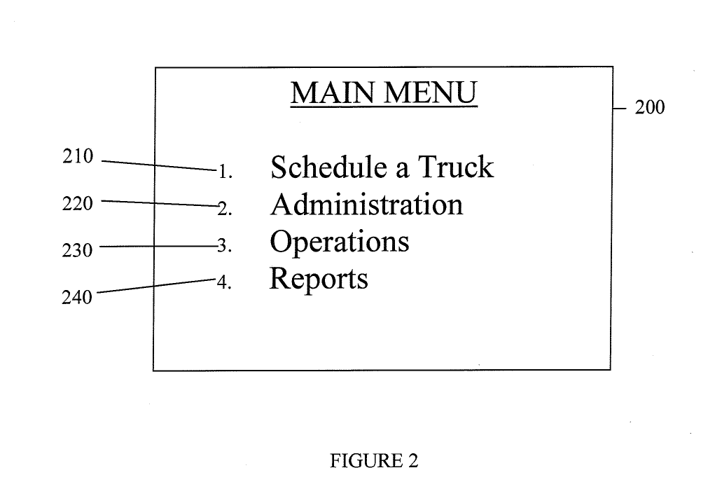

FIG. 2 is a diagram showing an exemplary main menu shown in FIG. 1. In this exemplary main menu, 200, a user has access to four sets of functionality. The first set, 210, relates to functionality needed to schedule a truck for arrival and unloading at a distribution center. The second function relates to the administrative functions 220 that might be needed to service the arrival and processing of a truck. Operational functionality 230 relates to functionality that is appropriate to the management of operations at the distribution center. Finally, reports functionality 240 can be accessed through the main menu. As noted above, the specific items of functionality that might be available under each of these menu selections may differ from user to user depending upon the privileges assigned to that user during set up of the account.

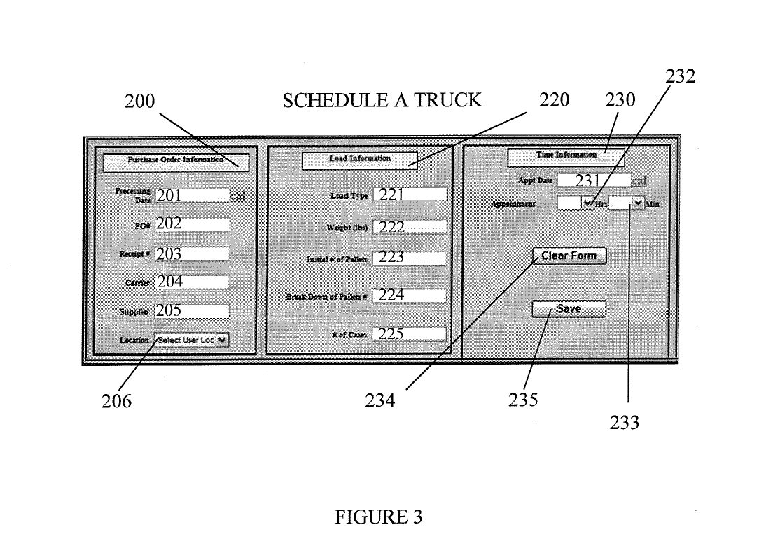

FIG. 3 is a diagram showing a screen for entry of information used to schedule a truck for servicing at a distribution center. The type of user that may have a need to schedule a truck maybe an independent trucker him(her)self, a shipper representative, an employee of the company receiving phone calls about pending deliveries from individuals or companies, the trucks of which may need service upon arrival of the distribution point. There are three main categories of information shown in this exemplary screen, namely purchase order information 200, load information 220 and time information 230. In the example shown, purchase order information includes a processing date 201, a purchase order number 202, a receipt number 203, and carrier identification 204, a supplier identification 205 and location information 206. The location information is shown as a drop down menu from which locations serviced by the company that operates the server can be selected from the drop down menu. The processing date 201 includes calendar functionality identified as CAL_ to the right of the box which allows calendar information to pop up and be utilized to select a processing date and have that date automatically inserted into the processing date field 201.

The load information 220 typically used includes the load type 221, meaning the type of cargo, the weight of the cargo 222, the number of pallets 223, the number of pallets broken down at the distribution point 224 and the number of cases that is associated with the load.

The time information 230 includes an appointment date 231 with the same type of calendar entry assistance (CAL) discussed in conjunction with the purchase order information 201, the time of the appointment (232) in hours and (233) in minutes. The form may be optionally cleared by depressing button 234 and may be optionally saved using the save button 235.

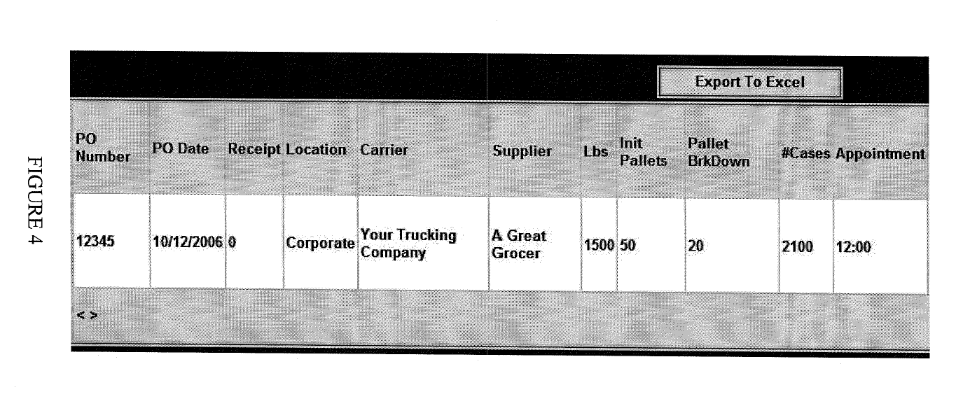

FIG. 4 is a diagram showing a screen for entry of information used to schedule a truck for servicing at a distributing center. This particular screen allows a user to export the information selected to an Excel® spreadsheet.

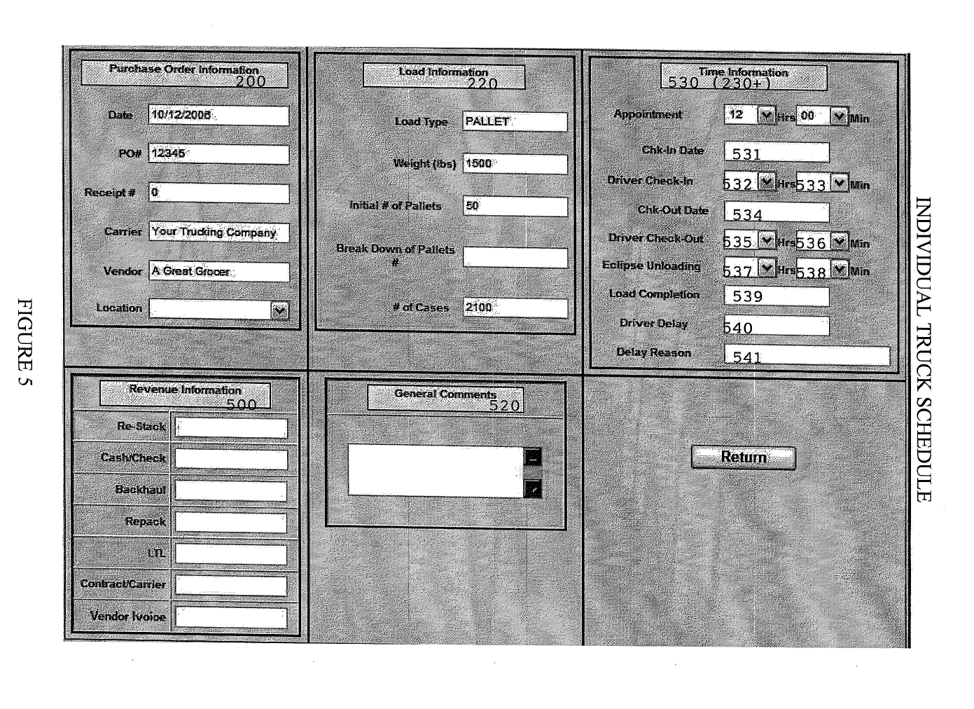

FIG. 5 is a diagram of an exemplary screen showing a view of purchase order information entered, preferably at the time of scheduling a truck for service at a distribution center. This view of the information is more complete than that shown in FIG. 3. Specifically, the information shown in the purchase order information section 200, the load information section 220 and part of the information shown in the time information 230 of FIG. 3 is replicated in this view of the information. Note that in addition to the information shown in FIG. 3, this view of the information shows revenue information 500 and general comments 600. In the time information block 530, the information shown in information 230 is replicated with additional information fields. The additional information fields include the check in date 531, the hours and minutes of the driver check in (532 and 533), the check out date 534 and driver check out time 535 and 536, the hours and minutes (537 and 538) of time required by the service provider (in this case Eclipse) who provided the unloading services to the incoming truck. Information about load completion, 539, driver delay 540 and the reason for any driver delay 541 are also viewable from this screen.

The revenue information 500 is utilized to provide information for billing as described more hereinafter. In addition, the general comments 520 allow for explanatory comments needed to place the context of the billing in focus. Finally, one may return to a higher level view in the navigational hierarchy by pressing the return button.

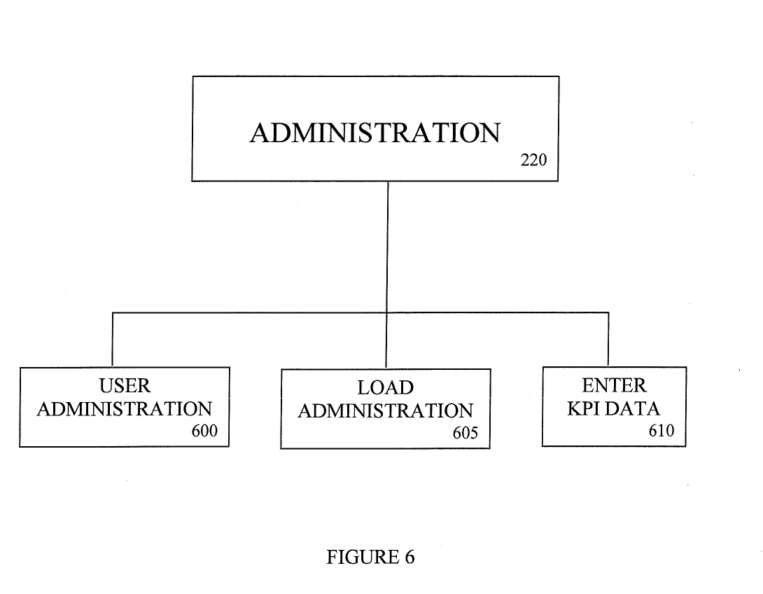

FIG. 6 is a diagram illustrating functionality accessible through the administration 220 selection of the main menu shown in FIG. 2. When the administration function is selected, there are three major sets of functionality available to a user. The first is the user administration function 600, second is the load administration function 605 and third is the enter KPI data function 610.

When the user administration functionality is selected, an authorized user can create and administer the user privileges for new users and for existing users. Usually this is done by a system administrator who has full privileges to administer the system. The user roles are defined together with the company relationship and the types of privileges available to that user. As noted before, this information will be accessed during user log in, to specify the functionality on the system available to the particular user. The system administrator can set and enforce security policies with respect to all users of the system.

When load administration is selected, an authorized user can input information relating to the off loading of a particular load by entering the information into the system that is related to that process.

When the enter KPI data function 610 is selected, key performance indicator data (KPI) relating to profitability of particular tasks undertaken with respect to a particular load, with respect to a particular customer of the service and particularly with respect to a location are entered so that appropriate performance metrics can be saved and reported to track the profitability of the personnel and management at a particular location.

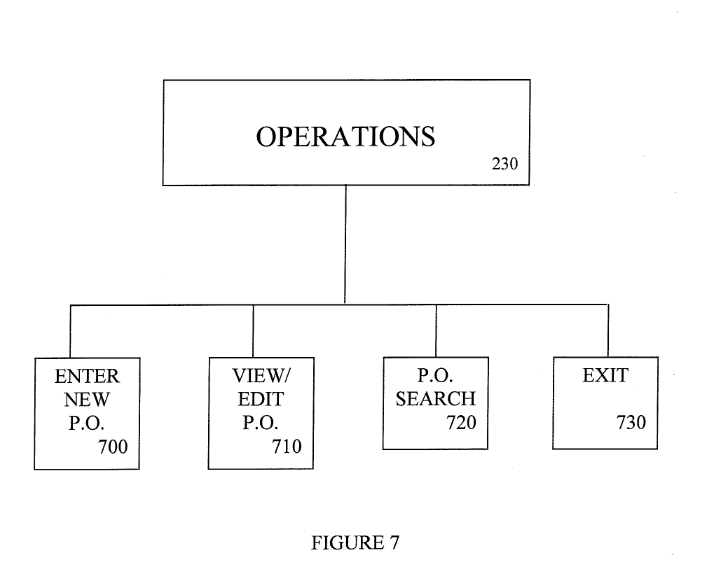

FIG. 7 is a diagram illustrating functionality accessible through the operations 230 selection of the main menu shown in FIG. 2. When the operations functionality 230 is selected from the main menu, four sets of functions can be selected. The first function involves the entry of a new purchase order. This function is utilized in response to customer request for service and are generally performed by employees of the service providing organization. As additional information is provided or changes to existing information relating to a purchase order are received, the company authorized user can view and edit the purchase order 710. Of course, changes to the purchase order maybe saved.

Sometimes, when a call comes in relating to a particular purchase order, it becomes necessary to search for that purchase order. This is accomplished using the functionality illustrated at item 720. Finally, the operations menu selection can be exited using item 730.

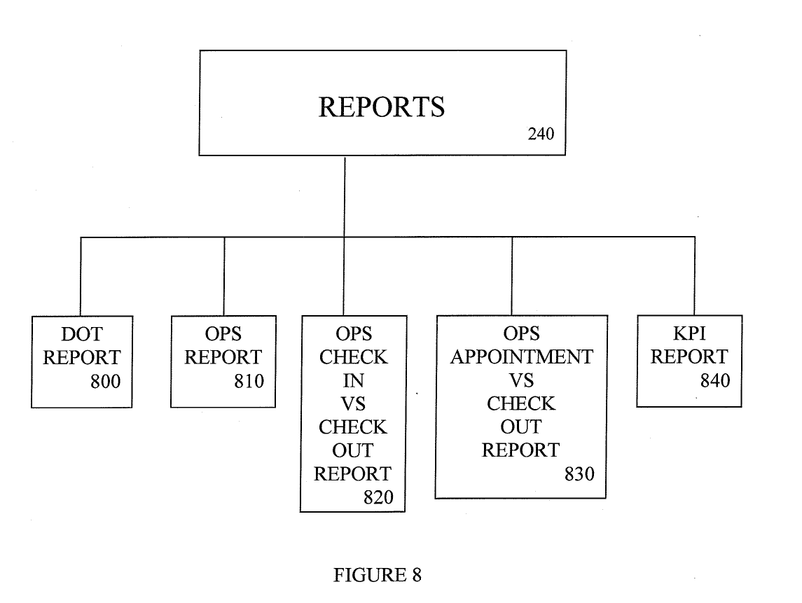

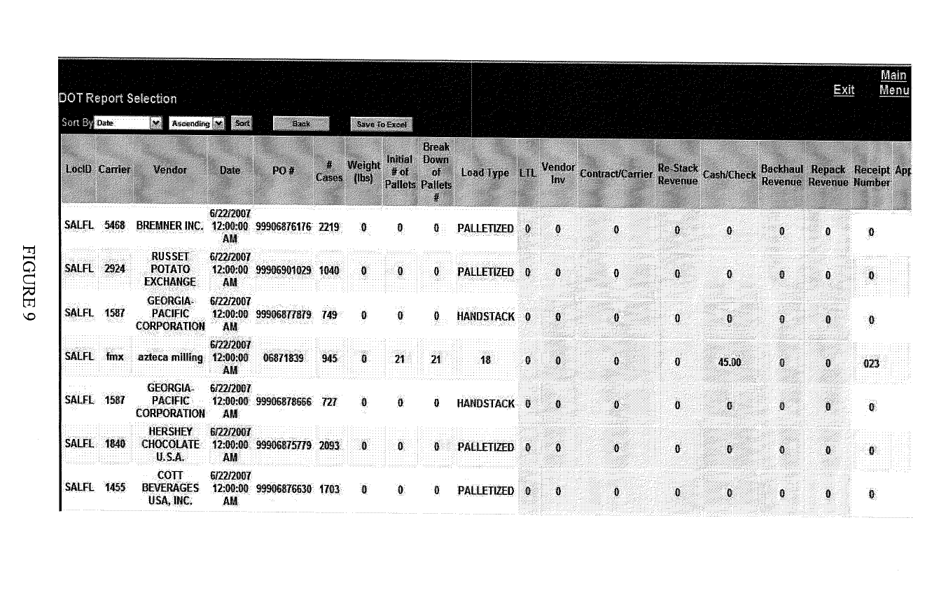

FIG. 8 is a diagram illustrating functionality accessible through the reports 240 selection of the main menu shown in FIG. 2. In this example, there are five types of reports available to a user. The first type of report relates to Department of Transportation reports. The second relates to operational reports 810. The third relates to operational check in and check out 820. Other reports include the operational appointment verses check out report 830 and the KPI report 840. As noted above, each of these reports maybe customized to the needs of a particular customer or user. The particular form of the type of report selected by each of these options, depends upon the log in privileges and information that are associated with the user requesting the report, based upon his log in status. Examples of DOT report 800 and OPS report 810 and KPI report 840 are shown in FIGS. 9, 11 and 15, respectively. The operations check in verses check out report 820 and the operations appointment verses check out report 830 provide information useful to determining quality of service and reliability for the customer.

FIG. 9 is an illustration of an exemplary DOT report shown in FIG. 8. The report, in this version, reports summary information about the location of the distribution center LocID, the carrier, the vendor or shipper, the date and time, the purchase order number, the number of cases, the weight, the initial number of pallets, the number of pallets broken down and the load type. In addition, information about the vendor invoice, contract carrier, revenue from restacking, cash or checks received, back haul revenue, repack revenue and receipt numbers can be included.

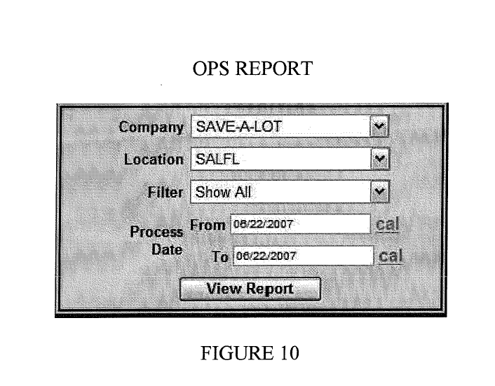

FIG. 10 is an illustration of an operational report selection window activated by selection of the OPS report functionality shown in FIG. 8. The OPS report selection window shown in FIG. 10, enables a person to selectively acquire information about a company, location and to filter that information according to certain criteria. In addition, one can specify the date range in which the report should be run.

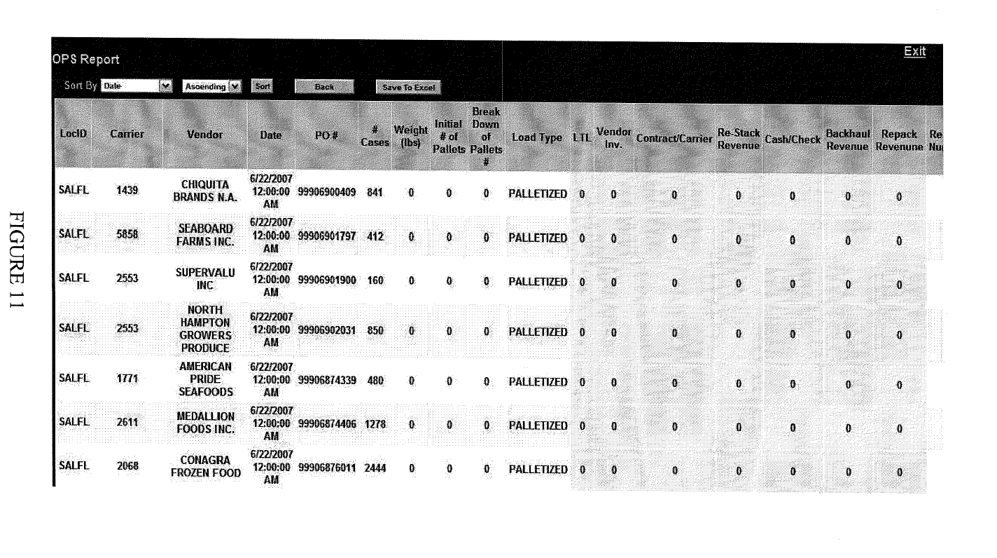

FIG. 11 shows an exemplary OPS report generated from information entered in the OPS report selection window of FIG. 10. The report has a format similar to that shown in FIG. 9 but is changed by the selection criteria entered in the OPS report selection window of FIG. 10.

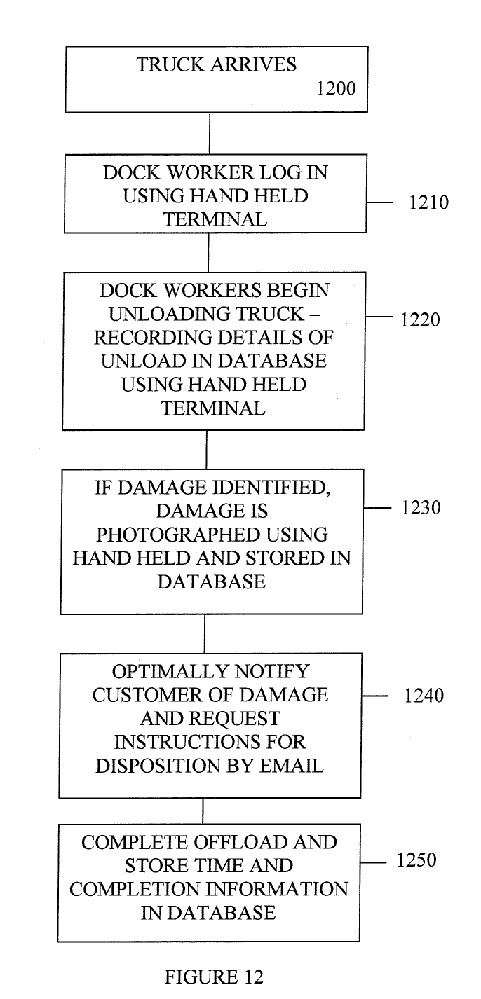

FIG. 12 is a block diagram of the steps users of the system disclosed herein take to process unloading of a vehicle at a distribution center. When a truck arrives, 1200, a dock worker logs in to the server using a hand held terminal such a Symbol Technologies MC9090 Terminal, illustrated hereinafter.

The dock workers begin unloading the truck and record the details of the services provided in the database using the hand held terminal. See step 1220. If damage is identified during the unloading process, the damage is photographed (1230) using the hand held terminal and stored in the database. Optionally, a dock worker can notify a customer of the damage, sending, if desired, an image of the damage, and request instructions for disposition by email (1240). Once the offload is completed, the time of completion and the completion information is stored in the database (1250) using the hand held terminal.

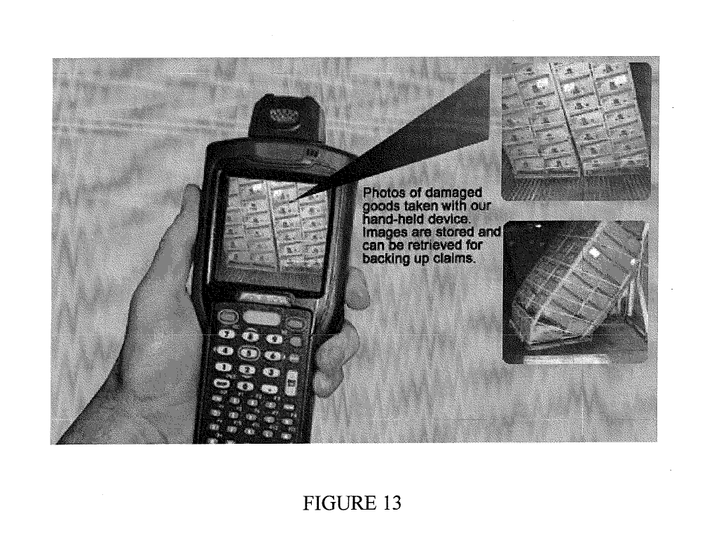

FIG. 13 is a picture showing use of a hand held terminal to capture an image of damage identified upon unloading to goods received. The hand held terminal has an image capture device, such as a camera input, for capturing images of the condition of goods during the unload. As noted above, preferably, the hand held terminal is a Symbol Technologies MC9090. In some cases, it maybe desirable to take pictures before off loading or before loading to document the condition of the goods. In the case where images are of such a bandwith that they constitute relatively large digital objects, file transfer protocol (FTP) software may be utilized to upload or download the large digital objects to the server or to a user or customer location.

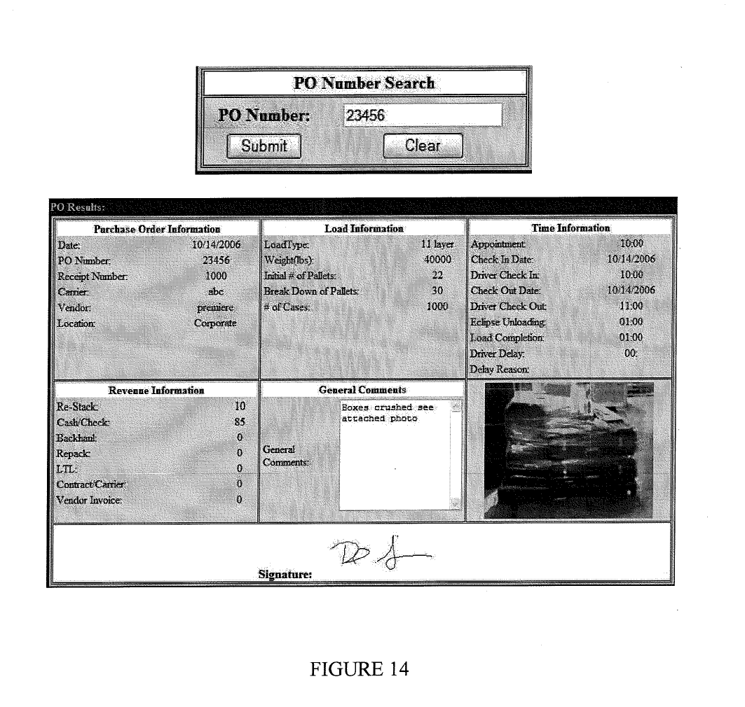

FIG. 14 is an exemplary view of purchase order information after job completion. Note that in this figure, there are general comments which, in this case, reads “boxes crushed see attached photo.” As one can see to the right of the general comments box in FIG. 14, there is a photo of damaged goods that is included in the completed purchase order. In addition, the signature of the person who participated in or supervised the unloading is included at the bottom.

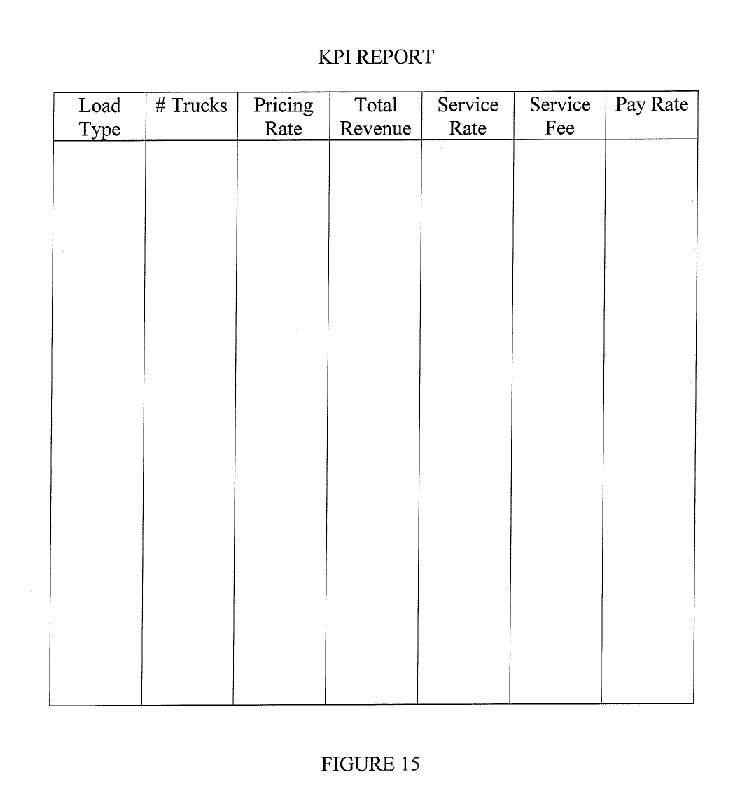

FIG. 15 is an exemplary layout of a key performance indicators (KPI) report. Again this is a location based report where information regarding activities at that location are aggregated and reported to measure the operational productivity and efficiency of that work location.

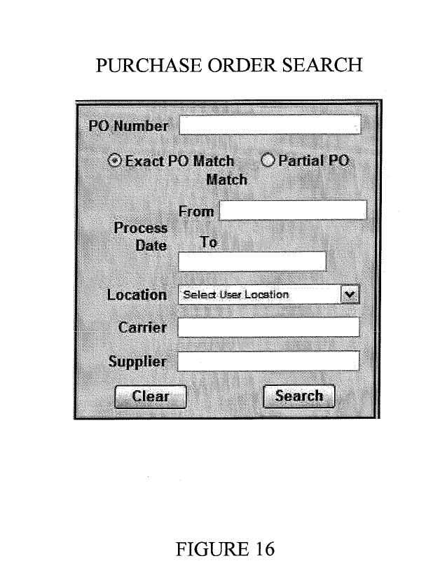

FIG. 16 is a diagram of a purchase order search screen. The search screen allows a user to identify information in the database that matches either exactly or partially the information provided by the user. For example, if a name of a carrier were entered, and one desired to report a purchase orders from that carrier, one could type in the carriers name, check partial purchase order match, and search for all purchase orders having that carriers name.

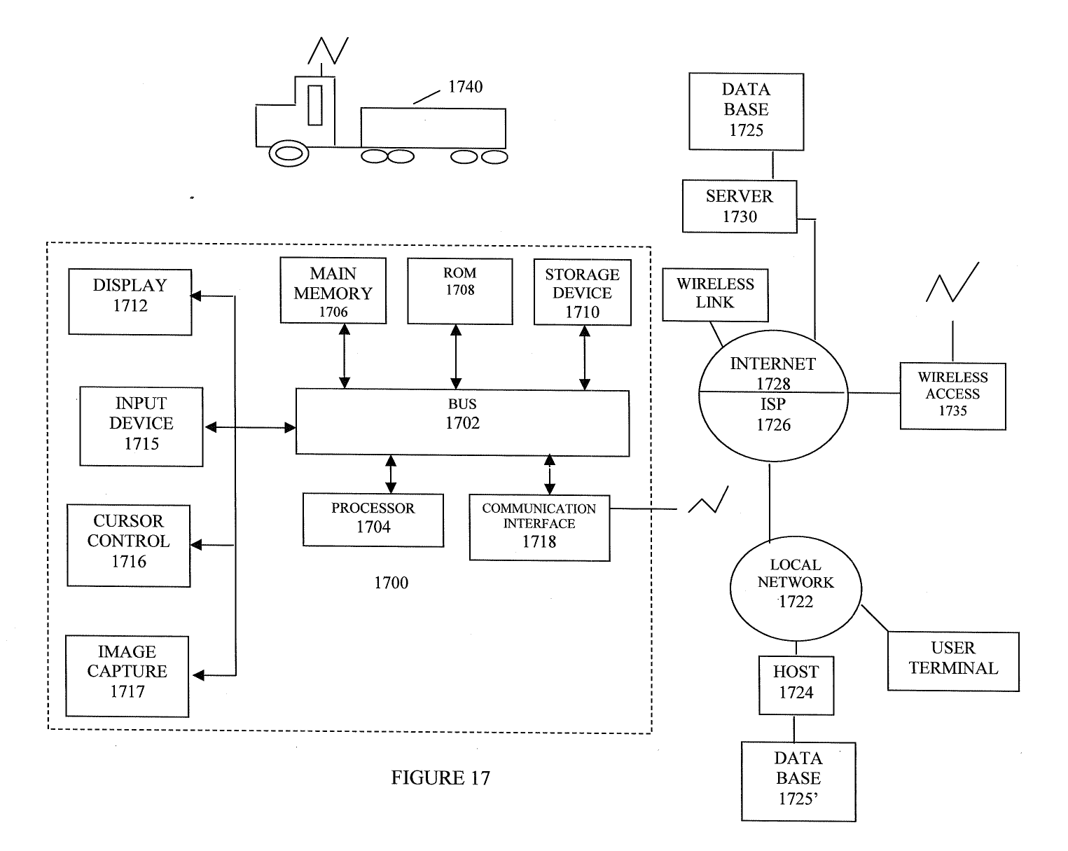

FIG. 17 is a diagram showing a hand held terminal and an exemplary configuration of the architecture of that hand held terminal. In addition, the hand held terminal is shown linked optionally to either a local network 1722 connected to a host 1724 with an appropriate database 1725′ or alternatively, through an Internet service provider 1726 to a server 1730 over an Internet link 1728. Note that the Internet service provider or the Internet itself may contain a wireless base station or network of stations (e.g. cell towers) to which mobile users such as truck 1740 can connect in order to access information in the database of the server.

At least portions of the invention are intended to be implemented on or over a network such as the Internet. An example of such a network is described in FIG. 17.

FIG. 17 is a block diagram that illustrates a computer system 1700 such as a hand held terminal upon which can be used to carry out the invention. Computer system 1700 includes a bus 102 or other communication mechanism for communicating information, and a processor 1704 coupled with bus 1702 for processing information. Computer system 1700 also includes a main memory 1706, such as a random access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Computer system 1700 further includes a read only memory (ROM) 1708 or other static storage device coupled to bus 1702 for storing static information and instructions for processor 1704. A storage device 1710, such as a magnetic disk or optical disk, is provided and coupled to bus 1702 for storing information and instructions.

Computer system 1700 may be coupled via bus 1702 to a display 1712, such as a cathode ray tube (CRT), for displaying information to a computer user. An input device 1714, including alphanumeric and other keys, is coupled to bus 1702 for communicating information and command selections to processor 1704. Another type of user input device is cursor control 1716, such as a mouse, a trackball, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Computer system 1700 operates in response to processor 1704 executing one or more sequences of one or more instructions contained in main memory 1706. Such instructions may be read into main memory 1706 from another computer-readable medium, such as storage device 1710. Execution of the sequences of instructions contained in main memory 1706 causes processor 1704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1704 for execution. Such a medium may take many forms, including but not limited to, non-volatile media, volatile media, and transmission media. Non-volatile media includes, for example, optical or magnetic disks, such as storage device 1710. Volatile media includes dynamic memory, such as main memory 1706. Transmission media includes coaxial cables, copper wire and fiber optics, including the wires that comprise bus 1702. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1704 for execution. For example, the instructions may initially be carried on a magnetic disk of a remote computer. The remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on bus 1702. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the world wide packet data communication network now commonly referred to as the “Internet” 1728. Local network 1722 and Internet 1728 both use electrical, electromagnetic or optical signals that carry digital data streams. The signals through the various networks and the signals on network link 1720 and through communication interface 1718, which carry the digital data to and from computer system 1700, are exemplary forms of carrier waves transporting the information.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718. The received code may be executed by processor 1704 as it is received, and/or stored in storage device 1710, or other non-volatile storage for later execution. In this manner, computer system 1700 may obtain application code in the form of a carrier wave.

While various embodiments of the present invention have been illustrated herein in detail, it should be apparent that modifications and adaptations to those embodiments may occur to those skilled in the art without departing from the scope of the present invention as set forth in the following claims.

1. Apparatus for managing the off-loading of vehicles at a distribution point, comprising:
a. a computing element programmed to act as a server and to provide a graphical user interface;
b. a database associated with the server;
c. a communications mechanism for connecting a user terminal to the server to enter data relating to off-loading of vehicles at said distribution point.

2. The apparatus of claim 1 in which the user terminal is a hand held terminal.

3. The apparatus of claim 2 in which the hand held terminal can capture images of a load at the distribution point.

4. The apparatus of claim 3 in which the hand held terminal is used to capture images of damage to the load.

5. The apparatus of claim 3 in which the hand held terminal can email captured images to an interested party.

6. The apparatus of claim 1 in which the user terminal is a computing element operated by a trucker or by a company shipping goods by truck.

7. The apparatus of claim 6 in which the user terminal is connected to said communications mechanism by a wireless link.

8. The apparatus of claim 6 in which the user terminal is used to by a trucker or a company shipping goods by truck to schedule resources at one or more distribution points.

9. The apparatus of claim 7 in which the resources scheduled include personnel for off loading for off-loading goods.

10. The apparatus of claim 8 in which a hand held terminal is used by dock personnel to record information about the goods offloaded at a distribution center and the personnel used to complete off-loading and to cause the information to be stored in said database.

11. The apparatus of claim 1 in which access to the server is controlled by a log-in identification and password.

12. The apparatus of claim 11 in which the functionality provided by the server to a user is determined by privileges associated with a particular log-in identification.

13. The apparatus of claim 11 in which the format of at least one report provided by the server is determined by a user's login.

14. A method of providing services related to the off-loading of vehicles at a distribution point, comprising the step of allowing vehicle personnel or a company shipping goods by vehicle to schedule resources needed for off-loading automatically.

15. The method of claim 14 in which scheduling resources is done over a wireless link.

16. The method of claim 14 in which scheduling of resources occurs without intervention of personnel from the company administering the resources.

17. The method of claim 14 in which information related to off-loading is recorded by a hand held terminal at a shipping dock and recorded in a database.

18. A computer program product for managing the off-loading of vehicles at at least one distribution point comprising:
a. a memory medium; and
b. computer instructions, stored on said memory medium, said computer instructions comprising instructions for allowing vehicle personnel or a company shipping goods by vehicle to schedule resources needed for off-loading automatically over a communication link without human intervention.

19. A computer program product for managing the off-loading of vehicles at a distribution point comprising:
a. a memory medium; and
b. computer instructions, stored on said memory medium, said computer instructions comprising instructions for recording information related to off-loading captured by a hand held terminal at a shipping dock for sending the information recorded to a database.

20. The computer program product of claim 19 in which the instructions permit capture of images by the hand held terminal.

21. The computer program product of claim 19 in which the instructions control the sending of information to the database over a wireless link.
